(19) United States
(12) Patent Application Publication
(10) Pub. No.: US 2009/0297799 A1
(43) Pub. Date: Dec. 3, 2009

(54) ANTIFOULING PRINTING SHEET

(76) Inventors: Takayoshi Nakasone, Chiba (JP); Norihiro Nakayama, Gifu (JP); Shinji Tanaka, Chiba (JP); Naoki Tanaka, Gifu (JP); Kazuyuki Takami, Gifu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/917,648

(22) PCT Filed: Jun. 21, 2006
(86) PCT No.: PCT/JP2006/312425

§ 371 Date: Jul. 23, 2009

(30) Foreign Application Priority Data
Jun. 22, 2005 (JP) 2005-182488
Mar. 10, 2006 (JP) 2006-066613

(51) Int. Cl. B32B 5/00; B32B 9/00

(52) U.S. Cl. 428/201; 428/411.1; 428/337; 428/480; 428/195.1

(57) ABSTRACT

The present invention provides an anti-fouling printing sheet, characterized by including a transparent support sheet, a hydrophilic anti-fouling layer provided on one side of the support sheet, and a printing surface provided on the opposite side of the support sheet; and an anti-fouling printed product and printed object having an image printed thereon. The anti-fouling printing sheet, printed product, and printed object exhibit a self-cleaning property based on a photocatalytic action for a long period of time.

### TECHNICAL FIELD

The present invention relates to an anti-fouling printing sheet having a self-cleaning property based on a hydrophilic action.

### BACKGROUND ART

Photocatalyst activation material, which is a hydrophilic material and exhibits a surface-cleaning effect based on super-hydrophilicity, is envisaged to exhibit a so-called anti-fouling effect; i.e., to keep surfaces of signboards or the like clean without performing a maintenance procedure.

In relation to printed products which are directly exposed to the atmosphere or exhibited for a long period, there has been proposed a weather-resistant printed product having a laminate structure which has at least a printing layer, and a protective layer including a photoactivity intercepting layer made of an inorganic substance for intercepting photoactivity and an anti-fouling layer exhibiting photoactivity, the printing layer and the protective layer being sequentially stacked (see Patent Document 1).

Even when stains such as dust and oil are deposited on a printing surface, the disclosed weather-resistant printed product enables decomposition of oily stains so as to facilitate cleaning or wiping the stains, and prevents staining of a surface thereof by dust. In addition, the weather-resistant printed product prevents light-induced color changing and fading thereof by synergism with a UV-blocking layer.

However, since the printed product disclosed in Patent Document 1 is formed by printing an image on a support and over-coating the printed support with an photoactivity-intercepting layer and a photoactive layer, the printed image may be blotted by an organic solvent for use in the coating process, or blotted during a heat drying step, or may be deteriorated in clearness through evaporation of an employed ink. From the economical viewpoint, printed products of the same image and dimensions are preferably mass-produced in a continuous line. However, in many cases, a small number of printed products of different images must be provided, and a coating step corresponding to each image must be performed, which is very cumbersome.

Another type of printed product has also been proposed (see Patent Document 2). The printed product has, on one side of a support, at least an anti-fouling layer containing a metal oxide exhibiting photocatalytic function, and an image has been transferred, through sublimation-transfer (i.e., penetrating through the anti-fouling layer) from the surface of the anti-fouling layer to the substrate.

However, the method disclosed in Patent Document 2 has a potential drawback in which a sublimated ink remains in the anti-fouling layer, resulting in a decrease in initial anti-fouling performance, since sublimation transfer printing is performed from the anti-fouling layer. Another potential drawback is a decrease in photocatalytic activity caused by gradual bleeding out of the sublimated ink.

In addition, since the anti-fouling layer is formed as a porous layer, the low-temperature sol-gel method must be employed, and the printing method is limited to sublimation transfer printing. Thus, the disclosed method is technically restricted and cannot be widely applied to printing processes of general purposes.

Meanwhile, with the spread of apparatuses such as personal computers and digital cameras, printers for use therewith have been graded up and can provide clear color images. Similarly, recent copy machines are also able to provide clear color copy images. Properties such as weather resistance of an ink employed in these apparatuses have been improved.

According to such a technical progress, it is very convenient that printed products are supplied not by a producer such as a printing company but by means of a color printer or a copy machine in an office, a home, a public office, etc. In particular, when a small number of printed products of different images of interest or contents for communication are provided, and such products are employed as, for example, advertisements and notices or as gardening materials, with the products being affixed to, for example, the objects in the outdoors or on the outer surface of a window pane, variations in living spaces can be realized.

For exhibiting such printed products in, for example, an open-air circumstance for a long period of time, stains caused by exhaust gas or dust must be cleaned up. Therefore, more preferably, an anti-fouling property which can eliminate such a cleaning process is provided.

However, the printed products disclosed in Patent Document 1 or 2 exhibiting anti-fouling property induced by a photocatalyst have the aforementioned drawbacks. Thus, at present, there have not yet been developed useful printing sheets which can receive an anti-fouling treatment that does not affect printing layers of a small number of printed products of various types or which can be widely applied to general printing processes.

In other words, there have not been realized anti-fouling printing sheets which can be produced through directly printing an image by means of a color printer or a copy machine and can be exhibited or decorated as anti-fouling printed products.

In order to maintain an image printed on a printing sheet in a clear state for a long period of time, conditions including the following i) to iii) must be satisfied: i) preventing fading of a dye contained in an ink; ii) preventing yellowing and deterioration of a support; and iii) preventing fouling of a surface of a printed product.

i) Measures against fading of a dye contained in an ink. In one proposed ink (see, for example, Patent Document 3), a pigment is coated with a hydrophilic polymeric compound which is transparent in the visible light region, in order to improve dispersibility of the pigment in water or a toner for use in a laser printer. Since the pigment is coated with a hydrophilic polymeric compound which is transparent in the visible light region, the pigment is not in contact with an oxidizing substance. Thus, printed products obtained by use of such a toner or ink are generally resistive to color fading.

However, since the pigment-coating polymeric compound itself has poor light fastness to UV light, color of the printed products gradually fades as weather resistance of the coating polymer decreases.

ii) Technique for preventing yellowing and deterioration of a support. Examples of preferred transparent supports include plastic films made of vinyl chloride polymer, acrylic polymer, polyethylene terephthalate (PET), or polyolefin. Generally, these supports have poor weather-resistance, which is not lower than that of the aforementioned pigment, and are gradually deteriorated by UV light, water, oxygen, etc. The deterioration mechanism varies in accordance with the polymer material forming the support, and cannot be described collectively. For example, in the case of PET, a considerable drop in strength is known to be induced after yellowing.

Many plastic films endowed with weather resistance are produced through kneading a plastic material with a weather-resistive agent. Although such plastic films effectively prevent a drastic drop in support strength, prevention of yellowing to a practical level cannot be attained.

iii) Technique for preventing fouling of a surface of a printed product. Conceivable causes for fouling a support surface are generally as follows; A) staining by adsorption of flying chemical substances on a support; B) staining by contact with and deposition of staining substances; and C) staining by electrostatic adsorption of floating microparticles. The anti-fouling technique is developed to cope with these causes.

In order to prevent such staining, a flat and inactive support surface is preferably provided in the case of A). In the case of B), the support surface preferably has very low surface energy so as to express super-water-repellency and super-oil-repellency. In the case of C), conductivity of the support surface is preferably increased.

The type of anti-fouling techniques of interest depends on the use of the printed products, and cannot be described collectively. However, a plurality of fouling mechanisms proceed in parallel under various environments. At present, there has not been developed a surface of printed products which can prevent fouling occurring through these mechanisms. That is, a satisfactory anti-fouling surface function has not been developed.

Patent Document 1; Japanese Patent Application Laid-Open (kokai) no. 2000-117187
Patent Document 2: Japanese Patent Application Laid-Open (kokai) no. 2003-43960

### Patent Document 3: WO02/26898 Pamphlet

### DISCLOSURE OF THE INVENTION

The present invention has been accomplished under the aforementioned circumstances. Thus, an object of the invention is to provide an anti-fouling printing sheet exhibiting a self-cleaning property based on a hydrophilic action for a long period of time. Another object is to provide an anti-fouling printing sheet, an anti-fouling printed product, and an anti-fouling printed object, on which an image can be printed by means of a printer or a copying machine for domestic or office use.

In order to attain the aforementioned objects, the present inventors have carried out extensive studies, and have found that the aforementioned objects can be attained by an anti-fouling printing sheet having a transparent support sheet in which a hydrophilic material; e.g., a photocatalyst-active layer is provided on one side of the support sheet via photoactivity-intercepting layer, and the opposite side of the support sheet serves as a printing surface, on which an image is printed, the anti-fouling printing sheet optionally having a UV-blocking layer. The present invention has been accomplished on the basis of this finding.

Accordingly, the present invention provides (1) an anti-fouling printing sheet, characterized by comprising a transparent support sheet, a hydrophilic anti-fouling layer provided on one side of the support sheet, and a printing surface provided on the opposite side of the support sheet; (2) an anti-fouling printing sheet, characterized by comprising a transparent support sheet having a thickness of 50 μm to 400 μm, a photocatalyst-active layer provided on one side of the support sheet via a photoactivity-intercepting layer, and a printing surface provided on the opposite side of the support sheet; (3) an anti-fouling printed product, characterized by comprising an anti-fouling printing sheet as recited in (1) or (2) above, and a printed image provided thereon; and (4) an anti-fouling printed object, characterized by comprising an anti-fouling printing sheet as recited in (3) above, and an adhesive layer provided thereon.

### BRIEF DESCRIPTION OF THE DRAWINGS

FIG. 1 is a schematic cross-section of the anti-fouling printing sheet produced in Example 1 of the present invention.

FIG. 2 is a graph showing results of XPS analysis of a photoactivity-intercepting coating layer produced in the Examples.

FIG. 3 is a schematic cross-section of the printed product produced in Example 1 of the present invention.

FIG. 4 is a schematic cross-section of a printing support sheet employed in Example 4 or 5 of the present invention.

FIG. 5 is a schematic cross-section of the printed product produced in Example 4 or 5 of the present invention.

FIG. 6 is a schematic cross-section of the printed product produced in Example 6 of the present invention.

### DESCRIPTION OF REFERENCE NUMERALS

1, 11 Anti-fouling printing sheet
2, 12 Transparent support sheet
2a, 12a Film support
2b, 12b, 12c UV-blocking layer
3, 13 Photoactivity-intercepting layer (composition-gradient layer)
4, 14 Photocatalyst-active layer (anti-fouling layer)
5 Ink-receiving layer
6, 19 Printing layer
16 Peelable film
17 Adhesive layer
18 Adhesive-coated peelable film
21 Reflective particles
22 Adhesive layer
23 Reflective sheet
10, 20, 30, 40 Printed product

### BEST MODES FOR CARRYING OUT THE INVENTION

The transparent support sheet which can be employed in the present invention is a support for a printing layer. The material of the support sheet is selected from organic materials which have a strength for imparting satisfactory strength to printed products and printed objects, which are less deteriorated and more durable in the open air and against exposure to sunlight, and which have at least such a transparency that a printed image can be visually recognized from the side of a photocatalyst-active layer.

Preferably, the transparent support sheet of the present invention is made of a material (e.g., a plastic material) which has transparency and exhibits high chemical adsorption, affinity, and compatibility to an printing ink.

Alternatively, the transparent support sheet which may be employed in the present invention may be formed of woven or non-woven fabric made of fiber such as transparent synthetic fiber or natural fiber, or synthetic paper.

A fiber-made transparent support sheet may be formed into film by means of a hot calendar roller or the like in accordance with a printing image of interest or other factors.

The aforementioned transparent support sheet may be formed of a plastic sheet, film, or the like. Examples of the material for forming the support sheets include acrylic resins such as poly(methyl methacrylate); styrene resins such as polystyrene and ABS resin; olefin resins such as polyethylene and polypropylene; polyester resins such as polyethylene terephthalate and polyethylene naphthalate; polyamide resins such as 6-nylon and 6,6-nylon; poly(vinyl chloride) resin; poly(vinylidene chloride) resin; polycarbonate resin; poly(phenylene sulfide) resin; poly(phenylene ether) resin; polyimide resin; polyether-imide resin; and cellulose resins such as cellulose acetate.

Of these, a polyethylene terephthalate sheet is more preferred, from the viewpoints of heat resistance during printing, mechanical strength, and other factors.

In the present invention, a transparent support sheet which has been subjected to treatment for enhancing weather resistance is preferably employed. For example, an additive is incorporated into the transparent support sheet. No particular limitation is imposed on the additive, and examples of the additive include organic UV-absorbers of a type such as benzophenol, benzotriazole, oxaloanilide, cyanoacrylate, or triazine; UV-scattering agents such as zinc oxide; hindered amine light-stabilizers; excitation energy absorbers; and radical scavengers. These additives may be used singly or in combination. Instead of incorporating an weather-resistance-enhancing agent into a transparent support sheet, an additional weather-resistance-enhancing layer may be provided on the transparent support sheet. In this case, the amount of weather-resistance-enhancing agent can be reduced, leading to cost reduction. Specifically, a UV-blocking layer containing a weather-resistance-enhancing agent is provided on one side of the transparent support sheet, whereby deterioration and surface cracking caused by TV light, brittle fracture, etc. can be prevented.

The transparent support sheet has a thickness of 50 μm to 400 μm, preferably 70 to 300 μm, from the viewpoint of a property such as conveyance performance in generally employed printers and copy machines.

From the viewpoint of the adaptability to generally employed printers and copy machines, the transparent support sheet generally has a size not more than A3 standard, more preferably a size of A4 standard, which is generally employed. The transparent support sheet is not limited to the aforementioned separate sheet, and may also be other printing supports such as a continuous rolled sheet having a predetermined width.

In order to further enhance adhesion to the photoactivity-intercepting layer or printing ink, the transparent support sheet may be subjected to surface treatment such as oxidation treatment or roughening, in accordance with needs. Examples of the oxidation treatment include corona discharge treatment, chromating (wet), flame treatment, hot air treatment, and ozone-UV radiation. Examples of the roughening include sand blasting and solvent treatment. These surface treatments may be selected in accordance with the type of support.

The transparent support sheet must have such a transparency that a printing layer can be visually recognized. However, the support sheet is not necessarily colorless but may be colored, so long as it is transparent.

A transparent support sheet having a total light transmittance of about 70% or higher may be employed in the invention.

However, when a printed image is viewed from the backside of the support with transmission of light through the support (e.g., in the case of stained glass or a decorative illumination signboard), visible light transmittance is preferably controlled to 5 to 40%. When the visible light transmittance is less than 5%, light transmission through the backside cannot be attained, whereas when the visible light transmittance is in excess of 40%, the support sheet imparts transparency to printed products, and color development of an ink may be insufficient.

The hydrophilic anti-fouling layer preferably has a photocatalytic action. For example, the hydrophilic anti-fouling layer may be formed of a hydrophilic hybrid material containing silica particles, hydrophilic inorganic film (e.g., silica film) produced through the sol-gel method, or a hydrophilic resin such as poly(vinyl alcohol) (PVA). When a hydrophilic anti-fouling layer having no photocatalytic action is provided, a photoactivity-intercepting layer is not necessarily provided. Instead, an adhesion layer for affixing the hydrophilic anti-fouling layer to a support may be required in some cases.

The hydrophilic anti-fouling layer preferably has a water contact angle of 10° or less, and a specific surface area Rf (Rf=S/S⁰, S represents a real surface area and S⁰ represents an apparent surface area) of 1.1 or less.

On a completely flat surface, having a specific surface area Rf of 1.0, when the water contact angle is 25° or less, anti-fouling effect is attained. On a sufficiently hydrophilic surface having a water contact angle 10° or less, the anti-fouling effect is satisfactorily attained.

When the specific surface area Rf is 1.1 or less, deposition of dust is prevented, and deposited dust is readily washed out by, for example, rain. Meanwhile, in the case of a rough surface having a specific surface area Rf of 1.0 or more, the measured water contact angle of the surface is reported to be lower than the real contact angle. The phenomenon is represented by Wenzel's equation:

cos θ=Rf×cos θ₀ (wherein θ₀ represents a water contact angle as measured on a flat surface).

On such a rough surface, anti-fouling effect can be attained when cos θ₀ is a predetermined level (0.906 (cos 25°) or more) Thus, on a rough surface having an Rf of 1.1, anti-fouling effect can be attained when the cos θ value (θ: apparent water contact angle) is 0.985 (1.1×cos 25°) or more; i.e., the apparent water contact angle must be 10°.

Therefore, according to the present invention, the term “anti-fouling hydrophilic surface” specifically denotes a surface which has a flatness represented by a specific surface area Rf (Rf=S/S⁰, S represents a real surface area and S⁰ represents an apparent surface area) of 1.1 or less, and which has a hydrophilicity represented by water contact angle of 10° or less.

When a photocatalytic layer is employed as an anti-fouling layer, a photoactivity-intercepting layer is provided on one surface of a transparent support sheet. The photoactivity-intercepting layer prevents deterioration of the transparent support sheet caused by a photocatalytic action and also prevents damage to a printing layer In addition, the photoactivity-intercepting layer enhances adhesion to the transparent support sheet. An intermediate layer generally employed in a photocatalyst film may be employed as the photoactivity-intercepting layer.

Such an intermediate layer is generally formed of a resin (e.g., silicone resin or acrylic-modified silicone resin) film having a thickness of several micrometers. Such a resin film may be employed in the present invention.

In the present invention, the aforementioned conventional intermediate layer may be employed as a photoactivity-intercepting layer. In this case, a surface of transparent support sheet may be subjected to the aforementioned surface treatment or may be laminated with a modifying material, in accordance with needs.

The modifying material preferably employed in the invention is a polyester or a compound having an epoxy group or a urethane group.

In the case where the printed product of the invention is required to have higher durability and weather resistance for exhibition in the open air, the photoactivity-intercepting layer is more preferably formed of an organic-inorganic complex composition-gradient layer, which contains a complex of an organic polymer compound and a metal oxide compound which are chemically linked together, and which has a composition-gradient structure in which the metal content changes continuously in the thickness direction of the layer. In an actual state, the metal oxide compound concentration is high at the interface between the photocatalyst-active layer and the photoactivity-intercepting layer, and the organic polymer compound concentration is high at the surface which the transparent support sheet abuts.

One exemplary photoactivity-intercepting layer employed in the present invention is formed from a coating composition containing at least one species selected from among metal alkoxide hydrolysis condensates (A) represented by formula (I):

MR¹ₓ(OR²)ₘ₋ₓ (I)

(wherein M represents a metal of Si, Ti, Al, or Zr; R¹ represents an alkyl group, an alkenyl group, an alkynyl group, an aryl group, an aralkyl group, or an acyl group; R² represents a C1 to C6 alkyl group; m is the valence of the metal M; and x is an integer of 0 to 2).

From the viewpoints of durability, scratch resistance, and weather-resistant, more preferably, the aforementioned photoactivity-intercepting layer of such an organic-inorganic complex composition-gradient layer is formed from a coating composition containing a metal alkoxide hydrolysis condensate (A) and at least one metal compound (B) (the metal being other than titanium) selected from among an inorganic salt, an organic salt, an inorganic oxide, and an alkoxide.

The aforementioned metal alkoxide hydrolysis condensate (A) may contain a compound for forming amorphous titanium oxide; i.e., a titanium alkoxide represented by formula (II):

TiR¹ₓ(OR²)₄₋ₓ (II)

(wherein R¹, R², and x have the same meanings as defined in relation to formula (I)), a hydrolysis condensate thereof, or a mixture thereof. Of these, a hydrolysis condensate is more preferred.

In the aforementioned formula (II), R¹ is a non-hydrolyzable group. Among non-hydrolyzable groups, the alkyl group is preferably a C to C20 alkyl group. The alkenyl group or the alkynyl group is preferably C2 to C20. The aryl group is preferably C6 to C20, and the aralkyl group is preferably C7 to C20. The acyl group is preferably a C2 to C20 aliphatic acyl group or an aromatic C7 to C20 acyl group (aroyl group).

The group OR² is a hydrolyzable group, and the C1 to C6 alkyl group represented by R² may be linear, branched, or cyclic. Examples of the alkyl group include a methyl group, an ethyl group, an n-propyl group, an isopropyl group, a n-butyl group, an isobutyl group, a sec-butyl group, a tert-butyl group, a pentyl group, a hexyl group, a cyclopentyl group, and a cyclohexyl group. x is an integer of 0 to 2. When a plurality of R¹ are present, these groups represented by R¹ may be identical to or different from one another. When a plurality of OR² are present, these groups represented by OR² may be identical to or different from one another.

Among titanium alkoxides represented by formula (II), titanium tetraalkoxide is preferred. Examples of preferred titanium tetraalkoxides include titanium tetramethoxide, titanium tetraethoxide, titanium tetra-n-propoxide, titanium tetraisopropoxide, titanium tetra-n-butoxide, titanium tetraisobutoxide, titanium tetrasec-butoxide, and titanium tetra-tert-butoxide. These alkoxides may be used singly or in combination of two or more species.

In the composition for forming the photoactivity-intercepting layer of the present invention, the solvent employed in hydrolysis condensation is preferably an alcohol. Among alcohols, an alcohol having 3 or more carbon atoms ether moiety is more preferred, from the viewpoints of control of hydrolysis condensation and stability of a condensation product.

Examples of the alcohol having a 3 or more carbon atoms ether moiety include a solvent which is interactive with titanium alkoxide. Specific examples include cellosolves such as ethylene glycol monomethyl ether, ethylene glycol monoethyl ether, ethylene glycol monopropyl ether, and ethylene glycol monobutyl ether; and other solvents such as diethylene glycol monomethyl ether, diethylene glycol monoethyl ether, diethylene glycol monopropyl ether, diethylene glycol monobutyl ether, propylene glycol monomethyl ether, propylene glycol monoethyl ether, propylene glycol monopropyl ether, and propylene glycol monobutyl ether. Among them, cellosolves are particularly preferred. These solvents may be used singly or in combination of two or more species.

When a hydrolysis condensate of titanium tetraalkoxide is employed, titanium tetraalkoxide is produced through hydrolysis condensation under the following conditions. The aforementioned alcohol is preferably used in an amount of 4 to 20 mol, more preferably 5 to 12 mol, with respect to 1 mol of titanium tetraalkoxide, and water is preferably used in an amount of 0.5 mol or more and less than 4 mol, more preferably 1 to 3.0 mol, with respect to 1 mol of titanium tetraalkoxide. The reaction is preformed in the presence of an acidic catalyst such as hydrochloric acid, sulfuric acid, or nitric acid, generally at 0 to 70° C., preferably 20 to 50° C. The acidic catalyst is generally used in an amount of 0.1 to 1.0 mol, preferably 0.2 to 0.7 mol, with respect to 1 mol of titanium tetraalkoxide.

The metal (other than titanium) compound serving as component (B) is a compound for inhibiting crystallization of amorphous titanium oxide and is selected from among inorganic salts, organic salts, and alkoxides, from the viewpoint of the inhibitory effect. Specific examples include salts such as aluminum nitrate, aluminum acetate, aluminum sulfate, and aluminum chloride; and zirconium nitrate, zirconium acetate, zirconium sulfate, and zirconium chloride; hydrates thereof; aluminum chelates such as aluminum triacetylacetonate; metal alkoxides such as zirconium tetra-n-propoxide, tetraethoxysilane, and phenyltrimethoxysilane; and hydrolyzates thereof; and condensates thereof. Of these, the metal other than titanium is preferably aluminum and/or zirconium, and aluminum nitrate and a hydrate thereof are particularly preferred. These metal compounds may be used singly or in combination of two or more species.

The metal (other than titanium) compound serving as component (B) may be directly added to a liquid containing the component (A), and no particular limitation is imposed on the order of addition of a plurality of metal compounds (B).

In the formation of the photoactivity-intercepting layer of the present invention, the metal (other than titanium) compound serving as component (B) is generally used in an amount of 5 to 50 mol % with respect to titanium atoms. When the amount is 5 mol % or more, satisfactory crystallization inhibitory effect can be attained, whereas when the amount is 50 mol % or less, physical properties intrinsic to amorphous titanium oxide can be fully attained. When aluminum nitrate is used as a metal (other than titanium) compound, it is particularly preferably used in an amount of 10 to 30 mol %.

The thus-prepared coating composition for forming the photoactivity-intercepting layer of the present invention has the aforementioned properties. The solid content of the composition is generally about 0.1 to about 30% by mass, preferably about 0.5 to about 20% by mass. The coating composition is applied to a support of interest in a thickness (dried state) of about 0.01 to about 2 μm, preferably 0.02 to 0.7 μm, and dried, for example, at ambient temperature or with heating in accordance with needs, whereby an amorphous titanium oxide complex coating film can be formed, the film being colorless and transparent and being prevented from generation of microcracks or similar defects of about 50 nm to about 5 μm.

The coating composition for forming the photoactivity-intercepting layer of the present invention may further contain (C) an organic component which can be chemically bonded to amorphous titanium oxide. By use of the composition, when a coating film is provided on the transparent support sheet, the amorphous titanium oxide content has a gradient from the surface of the coating film to the support sheet. Thus, a self-composition-gradient coating film can be formed from the composition.

Examples of preferred organic components (C) which can be chemically bonded to amorphous titanium oxide include organic polymer compounds formed through copolymerization of (a) an ethylenic unsaturated monomer containing no metal and (b) an ethylenic unsaturated monomer having a silicon-containing coupling group.

Examples of the ethylenic unsaturated monomer containing no metal (a) include an ethylenic unsaturated monomer represented by formula (III)

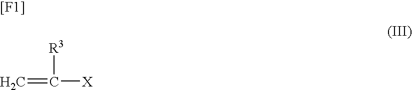

(wherein R³ represents a hydrogen atom or a methyl group; and X is a monovalent organic group). Examples of preferred component (a) include an ethylenic unsaturated monomer represented by formula (III-a)

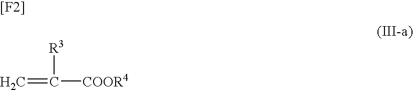

(wherein R³ represents a hydrogen atom or a methyl group; R⁴ represents a monovalent hydrocarbon group, or a hydrocarbon group having an epoxy group, a halogen atom, or an ether bond). These ethylenic unsaturated monomers may be used singly or in combination of two or more species.

In the ethylenic unsaturated monomer represented by the aforementioned formula (III-a), examples of preferred hydrocarbon groups of R⁴ include a C1 to C10 linear or branched alkyl group, a C3 to C10 cycloalkyl group, a C6 to C10 aryl group, and a C7 to C10 aralkyl group. Examples of the C1 to C10 alkyl group include a methyl group, an ethyl group, a n-propyl groups an isopropyl group, butyl groups, pentyl groups, hexyl groups, octyl groups, and decyl groups. Examples of the C3 to C10 cycloalkyl group include a cyclopentyl group, a cyclohexyl group, a methylcyclohexyl group, and a cyclooctyl group. Examples of the C6 to C10 aryl group include a phenyl group, a tolyl group, a xylyl group, a naphthyl group, and a methylnaphthyl group. Examples of the C7 to C10 aralkyl group include a benzyl group, a methylbenzyl group, a phenethyl group, and a naphthylmethyl group.

Examples of preferred hydrocarbon groups having an epoxy group, a halogen atom, or an ether bond include a C1 to C10 linear or branched alkyl group, a C3 to C10 cycloalkyl group, a C6 to C10 aryl group, and a C7 to C10 aralkyl group, each having the above group or atom. Examples of the substituting halogen atom include a chlorine atom.

Examples of the ethylenic unsaturated monomer represented by the aforementioned formula (III-a) include methyl (meth)acrylate, ethyl (meth)acrylate, propyl (meth)acrylate, butyl (meth)acrylate, hexyl (meth)acrylate, 2-ethylhexyl (meth)acrylate, cyclohexyl (meth)acrylate, phenyl (meth)acrylate, benzyl (meth)acrylate, glycidyl (meth)acrylate, 3-glycidoxypropyl (meth)acrylate, 2-(3,4-epoxycyclohexyl)ethyl (meth)acrylate, 2-chloroethyl (meth)acrylate, and 2-bromoethyl (meth)acrylate. These monomers may be used singly or in combination of two or more species.

Other than the above monomers, the ethylenic unsaturated monomers represented by the aforementioned formula (III) include styrene, α-methylstyrene, α-acetoxystyrene, m-, o-, or p-bromostyrene, m-, o-, or p-chlorostyrene, m-, o-, or p-vinyl phenol, 1- or 2-vinylnaphthalene, and polymerizable polymer stabilizers having an ethylenic unsaturated group such as an antioxidant, a UV-absorber, or a light-stabilizer each having an ethylenic unsaturated group. These monomers may be used singly or in combination of two or more species.

Examples of preferred ethylenic unsaturated monomers (b) having a silicon-containing coupling group include a compound represented by formula (IV);

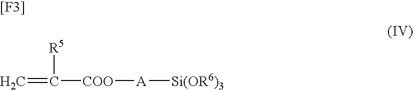

(wherein R⁵ represents a hydrogen atom or a methyl group; A represents a C1 to C4 alkylene group; and R⁶ represents a methyl group or an ethyl group). In formula (IV), three R⁶s may be identical to or different from one another.

Examples of the ethylenic unsaturated monomer represented by formula (IV) include 2-(meth)acryloxyethyltrimethoxysilane, 2-(meth)acryloxyethyltriethoxysilane, γ-(meth)acryloxypropyltrimethoxysilane, and γ-(meth)acryloxypropyltriethoxysilane.

These ethylenic unsaturated monomers (b) having a silicon-containing coupling group may be used singly or in combination of two or more species.

Through radical copolymerization, in the presence of a radical polymerization initiator, of (a) an ethylenic unsaturated monomer containing no metal and (b) an ethylenic unsaturated monomer having a silicon-containing coupling group, a compound having a self-composition gradient; i.e., an organic polymer compound (C) having silicon-containing coupling group is produced.

Formation of the photoactivity-intercepting layer of the present invention is as follows. The thus-produced organic polymer compound (C) having silicon-containing coupling group is dissolved in an appropriate solvent such as alcohol, ketone, or ether, and the obtained solution is mixed with a titanium alkoxide hydrolysis condensate (component (A)) and a metal compound (other than titanium compound) and/or a reaction mixture containing the compound (optionally diluted, if required) (component B), whereby the silicon-containing coupling group in the organic polymer compound is hydrolyzed, and reacted selectively with the titanium alkoxide hydrolysis condensate in the reaction mixture of (A)-Thus, a coating composition for forming an organic-inorganic complex composition-gradient film; i.e., a composition for forming the photoactivity-intercepting layer in the printing support of the present invention can be produced.

Notably, the diluting solvent employed for the reaction mixture containing a titanium alkoxide hydrolysis condensate is preferably a solvent containing an alcohol having 3 or more carbon atoms ether moiety for the aforementioned reason.

Through applying and drying such a coating composition, an organic-inorganic complex composition-gradient film can be reliably formed on a transparent support sheet. In the film having a favorable composition-gradient structure, a portion on the side of the transparent support sheet is virtually formed of the organic polymer compound, and a portion of the counter side is virtually formed of amorphous titanium oxide, with the compositional proportion continuously varying in the thickness direction. The thus-produced organic-inorganic complex composition-gradient film can serve as the photoactivity-intercepting layer.

Since the complex composition-gradient photoactivity-intercepting layer contains, as an inorganic component, amorphous titanium oxide, crystallization of the inorganic component can be suppressed even when it is subjected to an accelerated weathering test. Therefore, deterioration in mechanical strength, generation of cracks, a decrease in transparency, etc. can be prevented.

The amorphous degree of titanium oxide contained in the coating composition containing amorphous titanium oxide may be determined through a method disclosed in Japanese Patent Application Laid-Open (kokai) No. 2005-336334 (by the present applicant).

The complex composition-gradient film serving as a photoactivity-intercepting layer is formed on the transparent support sheet through application of the thus-produced coating composition of the present invention generally in a thickness (dried state) of 5 μm or less, preferably 0.01 to 1.0 μm, more preferably 0.02 to 0.7 μm through a known means such as dip coating, spin coating, spray coating, bar coating, knife coating, roller coating, blade coating, die coating, or gravure coating, followed by evaporating the solvent.

The composition-gradient structure of the photoactivity-intercepting layer may be confirmed through, for example, sputtering the coating film so as to gradually scrape a surface thereof and determining the change over time in relative carbon atom content and titanium atom content at the coating film surface through X-ray photoelectron spectroscopy or a similar method.

No particular limitation is imposed on the metal content of the composition-gradient film serving as a photoactivity-intercepting layer, and the metal content (as reduced to metal oxide) is generally 5 to 98% by mass, preferably 20 to 98% by mass, particularly preferably 50 to 95% by mass. No particular limitation is imposed on the polymerization degree and molecular weight of the organic polymer compound, so long as it can form film, and these properties may be appropriately selected in accordance with the type of the polymer compound, target physical properties of composition-gradient material, etc.

The photocatalyst-active layer of the present invention may be formed through solidifying, by use of a binder, of anatase-crystal-form titanium oxide, which is generally employed in a photocatalytic layer. However, in consideration of durability and weather resistance, the following composition is preferably employed.

Specifically, an improved coating composition for forming the photocatalyst-active layer of the present invention contains the aforementioned (A) and (B), and further contains (D) microparticles and/or silica microparticles having a photocatalytic function.

The microparticles having a photocatalytic function may be particles of titanium oxide mainly of anatase crystal form.

The microparticles of titanium oxide mainly of anatase crystal form (hereinafter may be referred to as anatase-crystal-form titanium oxide particles) are photocatalytic particles and may contain a small amount of rutile-crystal-form titanium oxide. Alternatively, visible-light-response photocatalytic particles which contain titanium nitride, low-valent titanium oxide, or the like may also be employed. The anatse-crystal-form titanium oxide particles preferably have a mean particle size of 1 to 500 nm, more preferably 1 to 100 nm, most preferably 1 to 50 nm, for attaining excellent photocatalytic function. The mean particle size may be determined through the laser beam scattering method.

Preferably, the titanium oxide particles further contain, inside a particle and/or a surface of a particle, a second component of at least one metal selected from among V, Fe, Co, Ni, Cu, Zn, Ru, Rh, Pd, Ag, Pt, and Au, and/or a metal compound thereof, in order to attain more excellent photocatalytic function. Examples of the metal compound include an oxide, a hydroxide, an oxyhydroxide, a sulfate, a halide, and a nitrate of these metals, and ions of these metals.

The second component content is appropriately selected in accordance with the type of material of the component.

The anatase-crystal-form titanium oxide particles may be produced through a known method. However, the titanium oxide particles are preferably used in the form of titanium oxide sol, for uniformly dispersing the particles in a coating liquid.

The titanium oxide sol may be produced through, for example, anatase-crystal-form titanium oxide powder is peptized in the presence of acid or alkali, or the particle size may be controlled through pulverization. Alternatively, the crystallite size and particle size of hydrous titanium oxide, which is produced through pyrolysis or neutralization-decomposition of titanium sulfate or titanium chloride, may be controlled through a physical or chemical method. A dispersion stabilizer may also be employed for attaining stable dispersion in a sol.

In the meantime, colloidal silica imparts a photocatalyst film with super-hydrophilicity which is maintained even when the film is placed in the dark.

Generally, a photocatalyst exhibits properties such as decomposing an organic substance present on a surface of the catalyst and expressing super-hydrophlicity by irradiation with UV light or the like. However, generally, such photocatalytic functions cannot be attained in the dark.

Through incorporation of colloidal silica into a photocatalyst film, the film also exhibits super-hydrophlicity even in the dark.

The colloidal silica is a colloidal product formed through dispersing high-purity silicon dioxide (SiO₂) in water or an alcoholic solvent, and generally has a mean particle size of 1 to 200 nm, preferably 5 to 50 nm. Since a silicon alkoxide hydrolysis condensate is a product which is in a state where silica formation is incomplete, it is readily eluted with water. Thus, a photocatalyst film containing silicon alkoxide hydrolysis condensate exhibits poor water resistance.

In contrast, since colloidal silica is a reaction-completed product in the form of microparticles, it is not readily eluted with water, and a photocatalyst film containing colloidal silica exhibits excellent water resistance.

The surface of the anti-fouling layer is continuously exposed to the atmosphere involving occasional rainfall. Therefore, the anti-fouling layer must have high water resistance. A satisfactory water resistance is determined through the following procedure. Specifically, a layer to be evaluated is immersed in warm water at 80° C. for 24 hours. When release of photocatalyst microparticles and/or silica particles and that of a water-resistant binder are 10% by mass or less, and the composition, morphology, and characteristics of the surface of the layer are not greatly changed, the layer is evaluated as a layer having satisfactory water resistance.

The anti-fouling layer is a thin film produced through film formation of a coating liquid containing photocatalyst microparticles and/or silica particles with a water-resistant binder. Similar to the composition as employed in the photoactivity-intercepting layer, the water-resistant binder contains a metal alkoxide hydrolysis condensate (A) or a compound for forming amorphous titanium oxide (B), and a metal compound (other than titanium compound), and/or a reaction mixture thereof (component C). By uniformly dispersing a predetermined amount of anatase-crystal-form titanium oxide sol (E) and optional colloidal silica in the water-resistant binder, a coating composition for forming the anti-fouling layer (photocatalyst-active layer) can be provided.

The thus-prepared coating composition having a photocatalytic function is applied to the photoactivity-intercepting layer formed on the transparent support sheet through a known means such as dip coating, spin coating, spray coating, bar coating, knife coating, roller coating, blade coating, die coating, or gravure coating, followed by drying with or without heating, to thereby form a photocatalyst film of interest; i.e., a photocatalyst-active layer. When drying is performed with heating, the heating temperature may be 200° C. or lower.

The thus-formed film is maintained at low temperature, whereby the formed photocatalyst film can exhibit a satisfactory photocatalytic function. Thus, the product can be suitably employed as the anti-fouling printing sheet of the present invention.

In order to enhance weather-resistance (fading resistance) of a printing ink, the laminate structure (from the anti-fouling layer (photocatalyst-active layer) to the opposite surface of transparent support sheet) of the anti-fouling printing sheet preferably exhibits a percent UV-blocking (≦350 nm) of 99% or higher. This is because decomposition of the dye caused by UV light of 380 nm or shorter resulting in color fading is prevented as high a degree as possible.

Between the anti-fouling layer (photocatalyst-active layer) and the transparent support sheet, a UV-blocking layer having a percent blocking of UV light of 380 nm or shorter of 50% or higher is preferably intervened. More preferably, the UV-blocking layer has a percent blacking of UV light having a wavelength of 380 nm or shorter of 90% or higher. Through intervention of the UV-blocking layer, coloring such as yellowing of the transparent support sheet itself can be prevented.

For example, entering of UV light of 380 nm or shorter into the transparent support sheet is cut through intervention of the UV-blocking layer, and a percent UV-blocking (380 nm or shorter) is controlled to 99% by a UV-absorber incorporated into the transparent support sheet itself, whereby the dye is completely protected against UV rays.

Such a UV-blocking layer, which contains a UV-absorber, may be provided on one side of the transparent support sheet. Alternatively, the layer may contain a UV-scattering agent, a hindered amine light-stabilizer (HALS), an excitation energy absorber, and a radical scavenger. These additives may be used singly or in combination. After formation of the UV-blocking layer, the total light transmittance of the laminate structure including the transparent support sheet is preferably 80% or higher from the viewpoint of visual recognition of the printed image of printed products.

Percent UV-blocking may be readily determined by means of a UV-Vis spectrum.

No particular limitation is imposed on the UV-absorber employed in the present invention, and any substance may be used so long as it absorbs UV light having a wavelength of 380 nm or shorter. The following compounds are preferably used.

Examples of the UV-absorber employed in the present invention include benzotriazoles such as 2-(2′-hydroxy-5′-methylphenyl)benzotriazole, 2-(2-hydroxy-3′,5′-di-t-butylphenyl)benzotriazole, 2-(2′-hydroxy-3′,5′-di-t-butylphenyl)-5-chlorobenzotriazole, 2-(2′-hydroxy-3′-t-butyl-5′-methylphenyl-5-chlorobenzotriazole, 2-(2′-hydroxy-3′,5′-di-t-amylphenyl)benzotriazole, 2-(2′-hydroxy-5′-t-butylphenyl)benzotriazole, and 2-(2′-hydroxy-5′-t-octylphenyl)benzotriazole; benzoates such as 2,4-di-t-butylphenyl-3,5-di-t-butyl-4-hydroxybenzoate; cyanoacrylate such as ethyl 2-cyano-3,5-diphenyl acrylate; benzophenones such as 2,4-dihydroxybenzophenone, 2-hydroxy-4-acetoxyethoxybenzophenone, 2-hydroxy-4-methoxybenzophenone, 2,2′-dihydroxy-4-methoxybenzophenone, 2,2′-dihydroxy-4,4′ dimethoxybenzophenone, 2-hydroxy-4-o-octoxybenzophenone, 2-hydroxy-4-i-octoxybenzophenone, 2-hydroxy-4-dodecyloxybenzophenone, 2,2′-dihydroxy-4,4′-dimethoxy-disulfobenzophenone disodium salt, 2-hydroxy-4-(2-hydroxy-3-methacryloxy)propoxybenzophenone, and 2-hydroxy-4-octadecyloxybenzophenone; salicylic esters such as phenyl salicylate, p-t-butylphenyl salicylate, and p-octylphenyl salicylate; and substituted acrylonitriles such as ethyl 2-cyano-3,3-diphenylacrylate and 2-ethylhexyl 2-cyano-3,3-diphenylacrylate. These UV-absorbers may be used singly or in combination of two or more species.

Examples of the light-stabilizer include bis(2,2,6,6-tetramethyl-4-piperidyl) sebacate, dimethyl succinate1-(2-hydroxyethyl)-4-hydroxy-2,2,6,6-tetramethylpiperidine polycondensate, poly[6-(1,1,3,3-tetramethylbutyl)imino-1,3,5-triazine-2,4-diyl][(2,2,6,6-tetramethyl-4-piperidyl)imino]hexamethylene[2,2,6,6-tetramethyl-4-piperidylimide], tetrakis(2,2,6,6-tetrarmethyl-4-piperidyl)-1,2,3,4-butanetetracarboxylate, (mixed 2,2,6,6-tetramethyl-4-piperidyl/tridecyl)-1,2,3,4-butanetetracarboxylate, N,N′-bis(3-aminopropyl)ethylenediamine-2,4-bis[N-butyl-N-(1,2,2,6,6-pentamethyl-4-piperidyl)amino]-6-chloro-1,3,5-triazine condensate, [N-(2,2,6,6-tetramethyl-4-piperidyl)-2-methyl-2-(2,2,6,6-tetramethyl-4-piperidyl) imino]propionamide, and hindered amines such as TINUVIN 770, 123, 144, and 622 (products of Ciba Geigy), SANOL LS-770, 765, 292, and 2626 (products of Sankyo Co., Ltd.), and ADK Stab LA-52, 57, and 62 (products of ADEKA Co., Ltd.). These light-stabilizers may be used singly or in combination of two or more species, and may be used with the aforementioned UV-absorbers.

Examples of the UV-scattering agent include inorganic materials such as metal oxide powder. Specific examples of the metal oxide powder include microparticulated powders of titanium dioxide, zinc oxide, cerium oxide, etc.; hybrid inorganic powder of titanium dioxide microparticles completed with iron oxide; and hybrid inorganic powder of cerium oxide microparticles surface-coated with amorphous silica. A UV-scattering agent is a material which exhibits UV-blocking effect based on scattering UV rays. Since UV scattering effect is considerably varied in accordance with the particle size of the agent, the mean particle size is preferably 5 μm or less, particularly preferably 10 nm to 2 μm. When the UV-scattering agent to be employed also has a photocatalytic activity, the particles are preferably surface-coated with a thin layer of a material such as water glass so as to suppress the photocatalytic activity.

On the printing surface of the anti-fouling printing sheet of the present invention, an ink-receiving layer may be provided.

A surface-improved ink-receiving layer enhances adhesion to an printing ink and may be formed through surface treatment such as oxidation treatment or roughening. Examples of the oxidation treatment include corona discharge treatment, chromating (wet), flame treatment, hot air treatment, and ozone-UV radiation. Examples of the roughening include sand blasting and solvent treatment. These surface treatments may be selected in accordance with the type of transparent support sheet and the type of printing ink. The ink-receiving layer varied in accordance with printing process. For example, the ink-receiving layer is a printing ink adhesion enhancing layer in a printing process such as offset printing or silk screen printing; an ink-receiving layer in ink-jet printing; or a toner-receiving layer in electrophotographic printing.

The ink-receiving layer suitably printed with a domestic ink-jet printer may be appropriately selected, in accordance with needs, from a variety of materials such as porous hybrid film containing silica or alumina and special hydrophilic resin such as a hot-melt ink-jet medium “Pre-make HLT” (product of Mitsubishi Plastics Inc.).

In the anti-fouling printing sheet of the present invention, a protective peelable film may be laminated on the surface of the photocatalyst-active layer.

A protective peelable film is provided on the surface of the photocatalyst-active layer for the following reasons: to protect a photocatalyst-active layer which is readily deteriorated by wear and scratch until use thereof based on expression of photocatalytic activity, and to prevent gathering (i.e., conveyance of a plurality of stacked sheets in a printing apparatus) in a printing step, whereby separate printing sheets can be conveyed.

Therefore, the surface of the peelable sheet provided on the photocatalyst-active layer is preferably subjected to roughening or other treatments. On the side of the printing sheet opposite the peelable sheet provided on the photocatalyst-active layer, an adhesive layer is formed. The adhesive layer facilitates provision of a peelable sheet and peeling in a final stage.

The adhesive is selected in consideration of factors such as the adhesion mode, adhesion effect, and adhesion power, to the photocatalyst-active layer. No particular limitation is imposed on the type of adhesive employable in the invention, and conventionally used adhesives of acrylic material, urethane material, silicone rubber, and rubber may be appropriately employed. Among them, an acrylic adhesive is more preferred, since it is readily controllable in terms of adhesion power and re-peelability.

The present invention also provides an anti-fouling printed product having an anti-fouling printing sheet and a printed image provided thereon, and an anti-fouling object An anti-fouling printed object having an anti-fouling printed product and an adhesive layer provided on a surface of the printed product.

No particular limitation is imposed on the method of printing on the printing sheet for producing the anti-fouling printed product of the present invention, and any method suitable for the printing sheet employed may be selected. For example, there may be employed plate printing such as lithographic printing (e.g., offset printing), intaglio printing (gravure printing), letterpress printing, or silk screen printing, or printing means such as an ink-jet printer, an electrostatic printer, sublimation ink transfer, or laser printing. In domestic cases, an ink-jet printer is generally employed.

When reversal printing (a printed image as viewed from the printing surface has a mirror image with respect to a normal view) is performed, the printed image can be recognized as a normal image as viewed from the photocatalyst-active layer.

In the case where the printed product of the present invention is affixed to the outer surface of a window pane, and the printed image is viewed mainly from inside the room, non-reversal printing is performed.

Through overprinting a color base (e.g., a white base) serving as a background on a printed product of interest, the printed image can be made to clearly stand out. One effective means is affixing the printed product onto a white support by use of, for example, an adhesive or an adhesive tape. When an opaque support which allows light transmission is used, the printed image can be made to stand out without completely blocking the light entering the room.

In the present invention, a reflective sheet which has a retroreflecting function (i.e., reflecting light to the light source) may be laminated on the printed product. The retroreflection may be effected by means of a layer in which microspherical or square prisms are arrayed.

By virtue of the retroreflecting function, visibility of a variety of printed products such as outdoor signboards (e.g., simple signboards used in, for example, the field of road construction field or the field of building construction, and printed products for warning in the nighttime) can be enhanced even in night or rainfall.

The printing ink employed in the invention may be a solvent-thinned pigment, a dye, and other varieties of inks.

The anti-fouling printed product of the present invention may be provided with a protective layer in order to protect the printing layer. The protective layer may be formed by through lamination of a plastic film or sheet or coating with a transparent resin.

The anti-fouling printing sheet of the present invention has a photocatalyst-active layer on one side of the transparent support sheet via a photoactivity-intercepting layer. That is, the anti-fouling printing sheet itself has anti-fouling action. Then, printing of a predetermined content is performed on a printing surface (the other side) of the anti-fouling printing sheet. Therefore, the anti-fouling printing sheet of the invention can be adapted to printing of various contents each being a small number, and can suitably provide a variety of self-cleaning-based anti-fouling printed products and objects such as advertisements and decorative signboards for open-air exposition, outdoor exposition (through window pane), etc. In addition, the anti-fouling printing sheet of the invention is intrinsically endowed with an anti-fouling function, and therefore, photographs and pictures of interest can be readily printed by means of a domestic printer, and the printed products can be exposed outdoors without staining the products.

During the printing step, by depositing a white pigment or a similar material on a printing surface, chromaticity of the printed image can be enhanced.

Through lamination of a reflective sheet having a retroreflecting function (by glass micro-beads, square prisms, etc.) on a printed product, the printed image can be clearly recognized in the nighttime, and such printed products can be effectively employed as anti-fouling guide boards, traffic-control signs, etc.

In the printing sheet of the present invention, the printing layer itself is not in direct contact with the photoactivity-intercepting layer or the photocatalytic layer. Therefore, a variety of inks can be used regardless of the type of material of these layers (e.g., solvent), whereby clearly colored and vivid signboards such as photographs, pictures, and posters can be printed. By virtue of the synergism with self-cleaning effect based on the photocatalytic action, the printing sheet provides remarkably clear images.

When the anti-fouling printing sheet of invention is installed to glass panes, walls, etc. of buildings and washed through application of water, the applied water spreads over the surface by super-hydrophilicity. In this case, the object (e.g., building) to which the printing sheet of the invention has been installed is expected to be cooled through evaporation of applied water.

Furthermore, the printing sheet of invention is envisaged to decompose NOx gas, which is an air pollutant, and environmental pollutants such as organic solvent and pesticides dissolved in water for removal thereof.

When the percent UV-blocking (380 nm or shorter) in the laminate structure (from the anti-fouling layer (photocatalyst-active layer) to the opposite surface of transparent support sheet) is controlled to 99% or higher, UV light (380 nm or shorter) cannot reach the ink dye. Therefore, fading and deterioration of the ink dye can be effectively prevented, whereby the printed products can be maintained clear for a long period of time.

As mentioned above, a complete anti-fouling effect is difficult to attain. There have already been reported some high-hydrophilic surfaces which can be readily washed with water to remove stains deposited thereon. Since a super-hydrophilic surface on which stains have been deposited can be washed by, for example, rainfall, the surface is prevented for a long period of time from staining under circumstances such as exposure to rainfall. Such a surface is considered an anti-fouling surface in a broad sense.

However, since stains cannot be completely washed out by, for example, rainfall, the surface is preferably endowed with a property of decomposing organic substance. Specifically, a photocatalytic material is incorporated into the anti-fouling layer to attain a complex state. Preferably, the photocatalytic material can be excited by UV light (380 nm or shorter) so as not to impair transparency of the printed media. Thus, titanium oxide, also having excellent hydrophilicity, is preferred.

Since the anti-fouling printing sheet of invention can be self-cleaned by rainfall or sprinkling of water by virtue of its photocatalytic function, the printing sheet can be used for a long period of time or repeatedly at a desired timing, while maintaining clearness of the surface. Examples of uses of the printing sheet of the invention include outdoor art exposition with internal illumination for simulating an outdoor theater; gardening materials (e.g., printed fences and flower beds); outdoor exposition materials which are attached/detached season by season (e.g., printed objects of Christmas trees, cloth carp, dolls, stained glass, and original calendars); and road-related materials (e.g., advertisement-on-guardrails and repairing materials).

### EXAMPLES

The present invention will next be described in detail by way of Examples and Comparative Examples, which should not be construed as limiting the invention thereto.

In each case, total light transmittance, haze, and composition gradient were determined through the following procedures.

### (Total Light Transmittance of Coating Film)

Total light transmittance and haze of the below specified samples were determined in accordance with JIS K7361-1, by means of the following apparatuses. Apparatus; Haze Mater NDH2000, product of Nippon Denshoku Industries Co., Ltd.

### (Composition Gradient; Determination Through X-ray Electron Microscopy)

### XPS Apparatus: PHI-5600, Product of ULVAC-PHI Inc.

In each case, a photoactivity-intercepting layer was scraped every three minutes through Ar sputtering (4 kV). After completion of each sputtering process, the carbon atom content and metal content of the exposed surface were determined, to thereby evaluate composition gradient.

### Example 1

### Formation of Film with a Photocatalytic Layer

### (1) Formation of Photoactivity-Intercepting Layer

Under nitrogen, methyl isobutyl ketone (424.0 g), methyl methacrylate (200.0 g), and methacryloxypropyltrimethoxysilane (23.5 g) were added to a 1 L separable flask, and the mixture was heated to 60° C. To the resultant solution, azobisisobutyronitrile (1.9 g) dissolved in methyl isobutyl ketone was added dropwise, to thereby initiate polymerization, and the reaction system was stirred for 30 hours, to thereby produce organic solution (a).

To a solution of titanium tetraisopropoxide (35.55 g) dissolved in ethyl cellosolve (70.02 g), a mixture of 60% by mass nitric acid (5.94 g), water (2.14 g), and ethyl cellosolve (27.39 g) was gradually added dropwise under stirring. The reaction mixture was stirred at 30° C. for 4 hours, to thereby produce solution (b).

Subsequently, the solution (b), ethyl cellosolve, and aluminum nitrate (heterometal compound) were mixed such that the aluminum nitrate content was adjusted to 15 mol % (with respect to Ti atoms) and the solid content of the solution was adjusted to 5% by mass, to thereby produce complex metal compound solution (c).

Then, the solution (a) (1.46 g), methyl isobutyl ketone (47.15 g), ethyl cellosolve (19.01 g), solution (c) (29.60 g), and colloidal silica dispersion (2.78 g) were mixed and stirred for 15 minutes. The mixture was maintained overnight at 5 to 10° C., to thereby produce organic-inorganic composition-gradient solution (e).

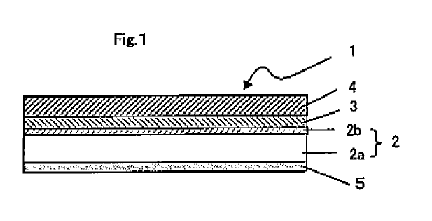

The organic-inorganic composition-gradient solution (e) was applied, through bar coating, to a surface of an ink-jet OHP sheet serving as a transparent support sheet 2 shown in FIG. 1 (JP-OHP10A, PET film base with an ink-receivinq layer, product of Sanwa Supply) on the side opposite the ink-receiving layer, to thereby form a photoactivity-intercepting layer 3 having a thickness of 100 nm.

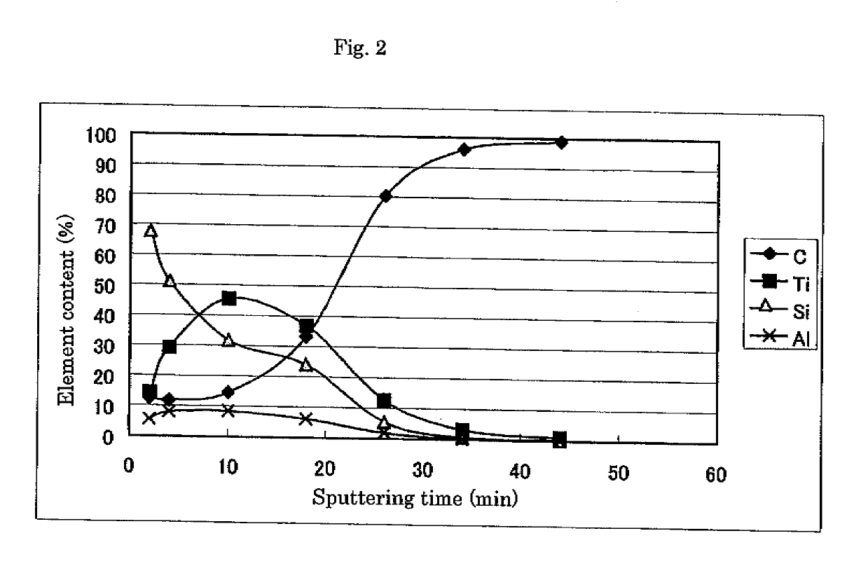

The composition gradient of the photoactivity-intercepting layer 3 was determined through XPS, to thereby confirm composition gradient of an organic component (inorganic component). The XPS results are shown in FIG. 2.

### (2) Formation of Photocatalyst-Active Layer and Manufacture Of Printing Support Through Adhesion Treatment

To a solvent mixture containing ethyl cellosolve (40.63 g) and 1-propanol (44.50 g), 60% by mass nitric acid (0.34 g), water (6.84 g), a photocatalyst dispersion (PC-201, solid content 20.7% by mass, product of Titan Kogyo K.K.) (0.483 g), and colloidal silica dispersion (Snowtex IPA-ST, solid content 30% by mass, product of Nissan Chemical Industries, Ltd.) (2.167 g) were added. The solution (b) (5.00 g) was further added to the mixture such that the total solid content was adjusted to 1% by mass, to thereby prepare photocatalyst liquid (f).

The photocatalyst solution was applied, through bar coating, to the ink-jet OHP sheet having the photoactivity-intercepting layer 3, to thereby form a photocatalyst-active layer 4 having a thickness of 40 nm. On the photocatalyst-active layer, a PET peelable film (not illustrate) (thickness; 30 μm) was cold-laminated, to thereby produce an anti-fouling printing sheet of interest,

### (3) Printing and Evaluation

On an ink-receiving layer 5 of the anti-fouling printing sheet 1 produced in (2), an image was reversal-printed (mirror image) by means of a domestic ink-jet printer (PM-970C, product of SEIKO EPSON CORP.) by use of an ink designated to the printer, to thereby produce printed products 10 having a photocatalyst-active layer 4. Each printed product 10 was affixed on a utility pole installed along a national road, and fouling feature and image deterioration were observed one year after affixation. Through observation, the printing layer 6 underwent virtually no staining, and the original image was maintained clear.

### Comparative Example 1

The same image as printed in Example 1 was printed on the same ink-jet OHP sheet having an ink-receiving layer (JP-OHP10A, product of Sanwa Supply) as employed in Example 1 by means of the same ink-jet printer. However, in Comparative Example 1, no photoactivity-intercepting layer or photocatalyst-active layer was provided.

In a manner similar to that of Example 1, each printed product was affixed on a utility pole installed along a national road, and fouling feature and image deterioration were observed one year after affixation. Through observation, staining caused by rainwater runoff was observed in the printing layer, and the original image was deteriorated.

### Example 2

On a PET-film-based color laser sheet (OHP sheet V516, for Docu Centre Color f360) of a size of A4 standard, the same photoactivity-intercepting layer and photocatalyst-active layer each having the same thickness were formed by use of the same compositions as employed in Example 1, to thereby produce an anti-fouling printing sheet.

The same image as printed in Example 1 was printed on the printing sheet by means of a laser printer (Docu Centre Color f360, product of Fuji Xerox).

In a manner similar to that of Example 1, each printed product was affixed on a utility pole installed along a national road, and fouling feature and image deterioration were observed one year after affixation. Through observation, the printing layer 9 underwent virtually no staining and the original image was maintained clear.

### Example 3

A coating liquid containing an HALS-hybridized UV-absorbing coating agent (UW series UV-G301, product of Nippon Shokubai Co., Ltd.) (100 parts by mass) and an isocyanate hardening agent (Desmodur N3200, product of Sumitomo Bayer Urethane Co., Ltd.) (12 parts by mass) was applied to a surface of an ink-jet OHP sheet serving as a transparent support sheet 2 shown in FIG. 1 (JP-OHP10A, PET film base with an ink-receiving layer, product of Sanwa Supply) on the side opposite the ink-receiving layer, followed by thermal cross-linking, to thereby form a UV-blocking film (thickness: 5 μm). The photoactivity-intercepting layer and the photocatalyst-active layer each having the same thickness as employed in Example 1 were provided, to thereby produce an anti-fouling printing sheet. In a manner similar to that of Example 1, an anti-fouling printed product having a photocatalyst-active layer produced from the printing sheet was affixed on a utility pole installed along a national road, and fouling feature and image deterioration were observed one year after affixation. Through observation, the printing layer 9 underwent virtually no staining and the original image was maintained clear.

### Example 4

### (1) Formation of a Photoactivity-Intercepting Layer and a Photocatalyst-Active Layer

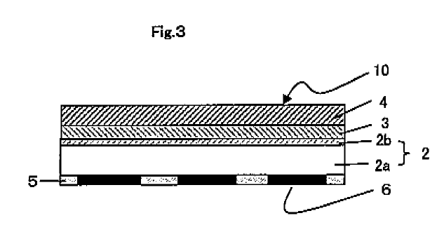

A coating liquid containing an HALS-hybridized UV-absorbing coating agent (UW series UV-G301, product of Nippon Shokubai Co., Ltd.) (100 parts by mass) and an isocyanate hardening agent (Desmodur N3200, product of Sumitomo Bayer Urethane Co., Ltd.) (12 parts by mass) was applied to an upper surface of a polyethylene terephthalate (PET) film support (T-60, product of Toray Industries, Ltd., thickness: 100 μm, width: 1,600 mm) 12a, followed by thermal cross-linking, to thereby form a UV-blocking film (thickness: 5 μm) 12b. Thus, a film support 12 shown in FIG. 4 having a total thickness of 105 μm was obtained. The same organic-inorganic composition-gradient solution (e) as employed in Example 1 was applied, through gravure coating, to the film support, to thereby form a photoactivity-intercepting layer 13 having a thickness of 100 nm, having the same inorganic-organic composition gradient as employed in Example 1. Subsequently, the same photocatalyst liquid (f) as employed in Example 1 was applied, through gravure coating, thereto, to thereby form a photocatalyst-active layer 14 having a thickness of 40 nm, whereby an anti-fouling printing support (sheet) 11 was produced.

### (2) Evaluation of Printing Support

Total light transmittance and haze of the thus-formed photocatalyst film serving as a printing support 11 were determined in the aforementioned manner. The total light transmittance was 91%, and the haze was 1.0%.

Through transmission UV-Vis spectrometry, the percent blocking of UV light having a wavelength of 380 nm or shorter of the laminate from the photocatalyst-active layer to the opposite side of the printing support 11 was determined. The percent UV blocking was 50% or less.

The printing support 11 was subjected to a 2000-hour accelerated weathering test by means of a carbon arc sunshine weather meter (SWM) (S300, product of Suga Test Instruments). After the test, the total light transmittance and haze of the printing support were 90% and 1.5%, respectively. The printing substrate exhibited small decrease in total light transmittance and small increase in haze.

### (3) Printing

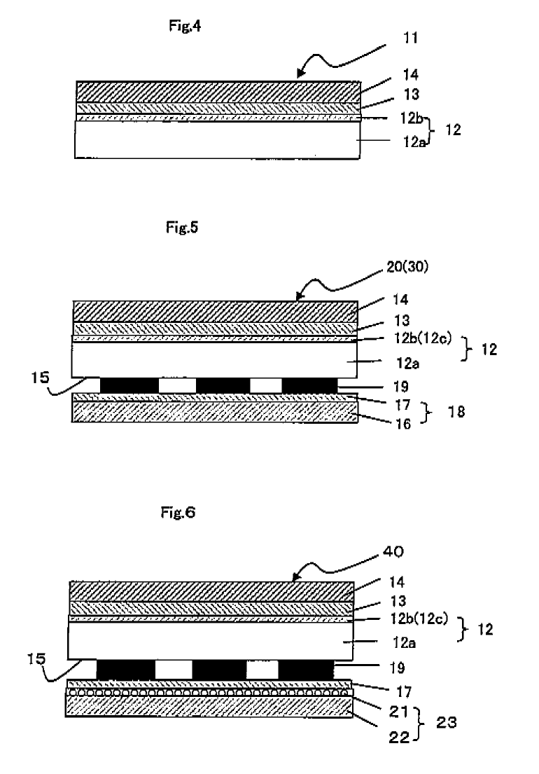

On a surface 15 opposite the photocatalyst-active layer 14 of the printing support 11 produced in (1) above, a printing layer 19 was formed. The printing layer had a picture image formed by means of an ink-jet printer (64S, product of Seiko Instruments Inc. (SII) by use of a solvent-thinned pigment (IP6 series) The printing layer was laminated with an adhesive-provided peelable film 18 (i.e., a PET peelable film 16 (thickness; 38 μm) having an adhesive layer 17). Another PET peelable film (thickness: 30 μm) (not illustrated) provided on the photocatalyst-active layer was peeled off, to thereby produce a printed product 20 shown in FIG. 5. The printed product 20 was affixed on a utility pole installed along a national road, and fouling feature and image deterioration were observed one year after affixation.

Through observation, the printing layer 19 underwent virtually no staining and the original image was maintained clear.

### Comparative Example 2

The same UV-blocking layer 12b as employed in Example 4 was provided on an upper surface of polyethylene terephthalate (PET) film support 12a (PET film (TP-60, product of Toray Industries, Ltd.) (total thickness: (105 μm). On the film support, a PET peelable film 8 (thickness: 38 μm) was laminated, to thereby provide a comparative sample.

### (Evaluation as Printing Support)

In a manner similar to that of Example 4, total light transmittance and haze of the film were determined. The total light transmittance and haze were 91% and 1.0%, respectively.

In a manner similar to that of Example 4, the comparative sample was subjected to a 2000-hour accelerated weathering test by means of a carbon arc sunshine weather meter (SWM) (S300, product of Suga Test Instruments). After the test, the total light transmittance and haze of the printing support were 90% and 3.0%, respectively.

### (Printing)

In a manner similar to that of Example 4, the same picture image printed in Example 4 was printed by means of an ink-jet printer (64S, product of Seiko Instruments Inc. (SIT) by use of a solvent-thinned pigment (IP6 series). The printing layer was laminated with the aforementioned peelable film. The printed product was affixed on a utility pole installed along a national road, and fouling feature and image deterioration were observed one year after affixation. Through observation, staining was observed in the printed image, and the original image was deteriorated.

### Example 5

### (1) Formation of a Photoactivity-Intercepting Layer and a Photocatalyst-Active Layer

A coating liquid containing an HALS-hybridized UV-absorbing coating agent (UW series UV-G301, product of Nippon Shokubai Co., Ltd.) (100 parts by mass) and an isocyanate hardening agent (Desmodur N3200, product of Sumitomo Bayer Urethane Co., Ltd.) (12 parts by mass) was applied to an upper surface of a UV-absorber-incorporated polyethylene terephthalate (PET) film support (HB-3, product of Teijin Du Pont film, thickness: 100 μm, width: 1,600 mm) 12a, followed by thermal cross-linking, to thereby form a UV-blocking film (thickness: 5 μm) 12b. Thus, a film support 12 shown in FIG. 4 having a total thickness of 105 μm was obtained. The same organic-inorganic composition-gradient solution (e) as employed in Example 1 was applied, through gravure coating, to the film support, to thereby form a photoactivity-intercepting layer 13 having a thickness of 100 nm having the same inorganic-organic composition gradient as employed in Example 1. Subsequently, the same photocatalyst liquid (f) as employed in Example 1 was applied, through gravure coating, thereto, to thereby form a photocatalyst-active layer 14 having a thickness of 40 nm, whereby an anti-fouling printing support (sheet) 11 was produced.

### (2) Evaluation of Printing Support

Total light transmittance and haze of the thus-formed photocatalyst film serving as a printing support 11 were determined in the aforementioned manner. The total light transmittance was 91%, and the haze was 1.0%.

Through transmission UV-V is spectrometry, the percent blocking of UV light having a wavelength of 380 nm or shorter of the laminate from the photocatalyst-active layer to the opposite side of the printing support 11 was determined. The percent UV blocking was 99% or higher.

The printing support 11 was subjected to a 2000-hour accelerated weathering test by means of a carbon arc sunshine weather meter (SWM) (S300, product of Suga Test Instruments). After the test, the total light transmittance and haze of the printing support were 90% and 1.5%, respectively. The printing substrate exhibited small decrease in total light transmittance and small increase in haze.

### (3) Printing

On a surface 15 opposite the photocatalyst-active layer 14 of the printing support 11 produced in (1) above, a printing layer 19 was formed. The printing layer had a picture image formed by means of an ink-jet printer (64S, product of Seiko Instruments Inc. (SII) by use of a solvent-thinned pigment (IP6 series). The printing layer was laminated with an adhesive-provided peelable film 18 (i.e., a PET peelable film 16 (thickness; 38 μm) having an adhesive layer 17). Another PET peelable film (thickness: 30 μm) (not illustrated) provided on the photocatalyst-active layer was peeled off, to thereby produce a printed product 30 shown in FIG. 5. The printed product 30 was affixed on a utility pole installed along a national road, and fouling feature and image deterioration were observed one year after affixation.

Through observation, the printing layer 19 underwent virtually no staining and the original image was maintained clear.

### Example 6

On the same printing support 11 (size of A3 standard; 297×420 mm) as employed in Example 5, an image (designs and characters) was printed by means of the same printer and ink as employed in Example 5, to thereby provide a printing layer 19. The printing layer was laminated with an adhesive-provided peelable film 18 (i.e., a PET peelable film 16 (thickness; 38 μm) having an adhesive layer 17). Subsequently, the peelable film 18 was peeled off, and an adhesive-provided reflective sheet 23 having a retroreflecting function based on a capsule lens (Scotch light-reflective sheet high-tensity grade 2870, product of Sumitomo 3M) was laminated thereon, to thereby produce a printed product 40 shown in FIG. 6.

The printed product having a reflective sheet laminated thereon 40 and a printed sheet having no reflective sheet were placed under a street lamp in the nighttime.

The image of the printed product having a reflective sheet laminated thereon was able to be recognized visually.

Next, a tester stood at a site 20 m apart from the printed product under a street lamp and confirmed that the image of both printed products could not be recognized. Then, the printed product was illuminated from the image side with head lamps of an automobile. Under the conditions, the image of the printed product having a reflective sheet laminated thereon was able to be recognized visually.

While the printed products were maintained under a street lamp, a tester then stood at a site 80 m apart from the printed product, and the printed product was illuminated from the image side with head lamps of an automobile. Under the conditions, the presence of the printed product having a reflective sheet laminated thereon was able to be clearly recognized visually, although the image thereon was not seen in detail.

Fouling feature and image deterioration were observed one year after the test. Through observation, the printing layer 19 underwent virtually no staining and the original image was maintained clear.

### Comparative Example 3

The same coating liquid as employed in Example 5, coating liquid containing an HALS-hybridized UV-absorbing coating agent (UW series UV-G301, product of Nippon Shokubai Co., Ltd.) (100 parts by mass) and an isocyanate hardening agent (Desmodur N3200, product of Sumitomo Bayer Urethane Co., Ltd.) (12 parts by mass), was applied to an upper surface of a UV-absorber-incorporated polyethylene terephthalate (PET) film support (HB-3, product of Teijin Du Pont film) 12a, followed by thermal cross-linking, to thereby form a UV-blocking film (thickness; 5 μm) 12b. Thus, a film support having a total thickness of 105 μm was obtained. On the film support, a PET peelable film 8 (thickness: 38 μm) was laminated, to thereby provide a comparative sample.

### (Evaluation as Printing Support)

In a manner similar to that of Example 5, total light transmittance and haze of the film were determined. The total light transmittance and haze were 91% and 1.0%, respectively.

In a manner similar to that of Example 5, the comparative sample was subjected to a 2000-hour accelerated weathering test by means of a carbon arc sunshine weather meter (SWM) (S300, product of Suga Test Instruments). After the test, the total light transmittance and haze of the printing support were 90% and 3.0%, respectively.

### (Printing)

In a manner similar to that of Example 5, the same picture image printed in Example 5 was printed by means of an ink-jet printer (64S, product of Seiko Instruments Inc. (SII) by use of a solvent-thinned pigment (IP6 series). The printing layer was laminated with the aforementioned peelable film. The printed product was affixed on a utility pole installed along a national road, and fouling feature and image deterioration were observed one year after affixation. Through observation, staining was observed in the printed image, and the original image was deteriorated.

### INDUSTRIAL APPLICABILITY

The anti-fouling printing sheet of the present invention has a photocatalyst-active layer on one side of the transparent support sheet via a photoactivity-intercepting layer. That is, the anti-fouling printing sheet itself has anti-fouling action. Then, printing of a predetermined content is performed on a printing surface (the other side) of the anti-fouling printing sheet. Therefore, the anti-fouling printing sheet of the invention can be adapted to printing of various contents each being a small number, and can suitably provide a variety of self-cleaning-based anti-fouling printed products and objects such as advertisements and decorative signboards for open-air exposition, outdoor exposition (through window pane), etc. In addition, the anti-fouling printing sheet of the invention is intrinsically endowed with an anti-fouling function, and therefore, photographs and pictures of interest can be readily printed by means of a domestic printer, and the printed products can be exposed outdoors without staining the products.

Since the image of the anti-fouling printed product and anti-fouling printing object of the present invention can be maintained for a long period of time, the product and object can be effectively used for a variety of purposes. Examples of uses of the printing sheet of the invention include outdoor art exposition and guide boards for outdoor exposition; signboards for advertisement; gardening materials (e.g., printed fences and flower beds); outdoor exposition materials (e.g., printed objects of Christmas trees, cloth carp, dolls, stained glass, and original calendars), which are affixed inside a domestic window pane for decorative purposes; and road-related materials (e.g., advertisement-on-guardrails and repairing materials).

When the anti-fouling (printing) sheet of invention is installed to glass panes, walls, etc. of buildings and washed through application of water, the applied water spreads over the surface by super-hydrophilicity. In this case, the object (e.g., building) to which the printing sheet of the invention has been installed is expected to be cooled through evaporation of applied water. Alternatively, the anti-fouling (printing) sheet of invention is envisaged to decompose NOx gas, which is an air pollutant, and environmental pollutants such as organic solvent and pesticides dissolved in water for removal thereof.

1. An anti-fouling printing sheet, characterized by comprising a transparent support sheet, a hydrophilic anti-fouling layer provided on one side of the support sheet, and a printing surface provided on the opposite side of the support sheet.

2. An anti-fouling printing sheet, characterized by comprising a transparent support sheet having a thickness of 50 μm to 400 μm, a photocatalyst-active layer serving as an anti-fouling layer provided on one side of the support sheet via a photoactivity-intercepting layer, and a printing surface provided on the opposite side of the support sheet.

3. An anti-fouling printing sheet as described in claim 1, wherein the transparent support sheet is formed from polyethylene terephthalate.

4. An anti-fouling printing sheet as described in claim 1, wherein an ink-receiving layer is provided on the opposite side of the transparent support sheet.

5. An anti-fouling printing sheet as described in claim 1, wherein the anti-fouling layer or photocatalyst-active layer has a water contact angle of 10° or less, and a specific surface area Rf (S/S⁰) of 1.1 or less, wherein S represents a real surface area, and S⁰ represents an apparent surface area.

6. An anti-fouling printing sheet as described in claim 1, wherein a laminate structure from the anti-fouling layer or photocatalyst-active layer to the opposite surface of the transparent support sheet exhibits a percent blocking of UV light having a wavelength of 380 nm or shorter of 99% or higher.

7. An anti-fouling printing sheet as described in claim 6, which has, between the anti-fouling layer or photocatalyst-active layer and the transparent support sheet, a UV-blocking layer having a percent blocking of UV light having a wavelength of 380 nm or shorter of 50% or higher.

8. An anti-fouling printing sheet as described in claim 2, wherein the photoactivity-intercepting layer is formed of an organic-inorganic complex composition-gradient layer, which contains a complex of an organic polymer compound and a metal oxide compound which are chemically linked together, and which has a composition-gradient structure in which the metal content changes continuously in the thickness direction of the layer, and virtually, the metal oxide compound concentration is high at the interface between the photocatalyst-active layer and the photoactivity-intercepting layer, and the organic polymer compound concentration is high at the surface which the transparent support sheet abuts.

9. An anti-fouling printing sheet as described in claim 8, wherein the photoactivity-intercepting layer is formed from a coating composition containing at least one species of a metal alkoxide hydrolysis condensate (A) represented by formula (I):
MR¹ₓ(OR²)ₘ₋ₓ (I)
(wherein M represents a metal of Si, Ti, Al, or Zr; R¹ represents an alkyl group, an alkenyl group, an alkynyl group, an aryl group, an aralkyl group, or an acyl group; R² represents a C1 to C6 alkyl group; m is the valence of the metal M; and x is an integer of 0 to 2).

10. An anti-fouling printing sheet as described in claim 9, wherein the metal alkoxide hydrolysis condensate (A) is formed from a film-forming coating composition containing a compound for forming an amorphous titanium oxide (B) which compound comprises a titanium alkoxide represented by formula (II):
TiR¹ₓ(OR²)₄₋ₓ (II)
(wherein R¹, R², and x have the same meanings as defined in formula (I)) and/or a hydrolysis condensate of the titanium alkoxide.

11. An anti-fouling printing support as described in claim 8, wherein the photoactivity-intercepting layer is formed from a coating composition containing a compound for forming an amorphous titanium oxide (B) and at least one metal (C) selected from among an inorganic salt, an organic salt, an inorganic oxide, and an alkoxide, the metal being other than titanium.

12. An anti-fouling printing sheet as described in claim 11, wherein the metal of the component (C) other than titanium is aluminum and/or zirconium.

13. An anti-fouling printing sheet as described in claim 11, wherein the metal compound of the component (C) is aluminum nitrate.

14. An anti-fouling printing sheet as described in claim 13, wherein the photoactivity-intercepting layer is formed from a self-composition-gradient composition which further contains an organic component (D) that can be chemically bonded to amorphous titanium oxide or to a hydrolysis condensate of alkoxide thereof, and which composition realizes a composition gradient in amorphous titanium oxide content or alkoxide hydrolysis condensate content, from the surface of the coating film to the support, when a coating film of the composition has been provided on the support.

15. An anti-fouling printing sheet as described in claim 14, wherein the photocatalyst-active layer is formed from a composition containing the components (B) and (C) and (E), the component (E) being microparticles having a photocatalytic function and/or silica microparticles.

16. An anti-fouling printing sheet as described in claim 15, wherein the microparticles having a photocatalytic function are formed of anatase-crystal-form titanium oxide.

17. An anti-fouling printing sheet as described in claim 16, wherein the anti-fouling layer is a thin film formed from a coating liquid containing photocatalyst microparticles and/or silica microparticles, and a water-resistant binder, and when the thin film has been immersed in water at 80° C. for 24 hours, release of the photocatalyst microparticles and/or silica particles and that of the water-resistant binder are 10% by mass or less.

18. An anti-fouling printing sheet as described in claim 17, wherein the water-resistant binder is formed from a coating composition containing at least one species of a metal alkoxide hydrolysis condensate (A) represented by formula (I):
MR¹ₓ(OR²)ₘ₋ₓ (I)
(wherein M represents a metal of Si, Ti, Al, or Zr; R¹ represents an alkyl group, an alkenyl group, an alkynyl group, an aryl group, an aralkyl group, or an acyl group; R² represents a C1 to C6 alkyl group; m is the valence of the metal M; and x is an integer of 0 to 2).

19. An anti-fouling printing sheet as described in claim 18, wherein the metal alkoxide hydrolysis condensate (A) is formed from a film-forming coating composition containing a compound for forming an amorphous titanium oxide (B) which compound comprises a titanium alkoxide represented by formula (II):
TiR¹ₓ(OR²)₄₋ₓ (II)
(wherein R¹, R², and x have the same meanings as defined in formula (I)) and/or a hydrolysis condensate of the titanium alkoxide.

20. An anti-fouling printing support as described in claim 17, wherein the water-resistant binder is formed from a coating composition containing a compound for forming an amorphous titanium oxide (B) and at least one metal (C) selected from among an inorganic salt, an organic salt, an inorganic oxide, and an alkoxide, the metal being other than titanium.

21. An anti-fouling printing sheet as described in claim 20, wherein the metal of the component (C) other than titanium is aluminum and/or zirconium.

22. An anti-fouling printing sheet as described in claim 20, wherein the metal compound of the component (C) is aluminum nitrate.

23. An anti-fouling printing sheet as described in claim 5, wherein a protective peelable film is laminated on a surface of the photocatalyst-active layer and the ink-receiving layer.

24. An anti-fouling printed product characterized by comprising an anti-fouling printing sheet as recited in claim 1, and a printed image provided thereon.

25. An anti-fouling printed product as described in claim 24, on which a reflective sheet is laminated.

26. An anti-fouling printed object characterized by comprising an anti-fouling printed product as recited in claim 24, and an adhesive layer provided on a surface of the printed product.

27. An anti-fouling printing sheet as described in claim 2, wherein the transparent support sheet is formed from polyethylene terephthalate.

28. An anti-fouling printing sheet as described in claim 2, wherein an ink-receiving layer is provided on the opposite side of the transparent support sheet.

29. An anti-fouling printing sheet as described in claim 2, wherein the anti-fouling layer or photocatalyst-active layer has a water contact angle of 10° or less, and a specific surface area Rf (S/S⁰) of 1.1 or less, wherein S represents a real surface area, and S⁰ represents an apparent surface area.

30. An anti-fouling printing sheet as described in claim 2, wherein a laminate structure from the anti-fouling layer or photocatalyst-active layer to the opposite surface of the transparent support sheet exhibits a percent blocking of UV light having a wavelength of 380 rim or shorter of 99% or higher.

31. An anti-fouling printed product characterized by comprising an anti-fouling printing sheet as recited in claim 2, and a printed image provided thereon.
